(19) United States
(12) Patent Application Publication
(10) Pub. No.: US 2005/0025701 A1
(43) Pub. Date: Feb. 3, 2005

(54) Steam reforming catalyst composition and process

(75) Inventors: Ramanath Narayan Bhat, Billerica, MA (US); Nayantara Bhat, Billerica, MA (US)

Correspondence Address: Ramanath Bhat, 7 Dale Street, Billerica, MA, 01821, US

(73) Assignee: Millennium Research Laboratories, Inc., Woburn, MA (US)

(21) Appl. No.: 10/630,409

(22) Filed: Jul. 30, 2003

(51) Int. Cl. C01B 3/26

(52) U.S. Cl. 423/652; 502/303

(57) ABSTRACT

A method for producing novel catalysts comprising of Group VIII metal along with a partially reducible metal oxide, zirconium oxide, lanthanum oxide and aluminum oxide is disclosed. These novel catalysts retain their catalytic activity even in the presence of significant quantities of sulfur compounds. This makes them attractive in the conversion of hydrocarbons into hydrogen; a process for the same is also disclosed.

### FIELD OF THE INVENTION

This invention pertains to a Group VIII metal—partially reducible metal oxide-zirconium oxide-lanthanum oxide-aluminum oxide catalyst compositions, a method of producing them and a process for the conversion of hydrocarbons into hydrogen using the novel catalyst composition. The novel catalysts retain their catalytic activity even in the presence of significant quantities of sulfur compounds.

### BACKGROUND OF THE INVENTION

Hydrocarbons are converted into hydrogen by a combination of steam reforming and water gas shift processes. Steam reforming is a process wherein hydrocarbons are reacted with steam in the presence of catalysts and converted into a mixture of hydrogen and carbon monoxide at elevated temperatures and pressures. The reaction is endothermic. If methane is the hydrocarbon, the chemical reaction can be written as
CH₄+H₂O═CO+3H₂.

It is the process of choice for the generation of hydrogen required for the manufacture of ammonia, methanol, hydrotreating of petroleum fractions and in the production of hydrocarbons by the Fischer-Tropsch process. Steam reforming can also be used to generate the hydrogen needed for polymer electrolyte membrane fuel cells from fuels such as natural gas and gasoline. Hydrogen is manufactured usually by a four step process: The hydrocarbon feedstock is first purified by removal of all sulfur compounds to a level below 0.1 ppm by hydrodesulfurization over cobalt-molybdenum or nickel-molybdenum sulfide catalysts followed by absorption of the H₂S formed in ZnO beds. In the second step, the hydrocarbon stream is reacted in an endothermic reaction with excess steam at 800-1000° C. in the presence of solid catalysts, usually based on nickel supported on insulators like silica, alumina, magnesia or calcium aluminate and converted to a mixture of hydrogen, carbon monoxide and carbon dioxide. In the third stage, the carbon monoxide in the stream is reacted with steam over catalysts by the so-called water gas shift reaction and converted to carbon dioxide and more hydrogen according to the reaction:
CO+H₂O═CO₂+H₂

The water gas reaction is exothermic It is equilibrium limited, the exit concentration of CO increasing with temperature. The process is, hence, carried out in 2 stages, a high temperature shift (HTS) stage in the range 350-500° C. using an iron oxide-chromia catalyst and a low temperature shift (LTS) stage using a copper-zinc oxide-alumina catalyst in the range 180-250° C. The concentration of CO at the exit of the LTS stage, in the range of 0.2-0.8%, is still too high for many applications of hydrogen and must be reduced to below 1 ppm. This is done in the fourth stage, where after removal of the CO₂, the CO is either hydrogenated to methane over a nickel methanation catalyst or preferentially oxidized to CO₂ over platinum-based catalysts.

Generation of hydrogen by steam reforming and water gas shift reactions of hydrocarbons is very well known in the prior art and has been extensively described in the patent literature. U.S. Pat. No. 4,906,603 describes a catalyst for the steam reforming of hydrocarbons, which contains nickel on an alumina/calcium aluminate support, which is doped with 0.2 to 10% by weight of titanium dioxide. The titanium dioxide was claimed to have the effect that the calcium aluminate is at least partially in the form of a hibonite phase in an alpha alumina matrix. The improved catalyst composition has the effect of improving the mechanical and thermal stability, in particular the thermal shock resistance of the catalyst thereby prolonging the effective, useful life of the catalyst. U.S. Pat. No. 6,238,816 claims a sulfur tolerant catalyst comprising an active catalytic phase and a catalyst support phase plus a promoter. Examples of the active catalyst phase included Ag, Co, Cu, Fe, Pd and Pt. The catalyst supports were ceria, mullite or zirconia and the promoters were oxides of bismuth, calcium, lanthanum or magnesium. The catalysts exhibited stable performance for up to 500 hours in the steam reforming of diesel and jet fuel fractions containing 0.3% sulfur. U.S. patent application 20010032965 claims a superior steam reforming catalyst comprising a spinel, alumina and a metal selected from Rh, Ir, Ni, Pd, Pt, Ru and carbides of Group IVb. In the steam reforming of methane, the catalyst exhibited more than 90% conversion and good CO selectivity even after 1000 hours of operation at a steam to carbon ratio of 3. U.S. Pat. No. 6,436,363 describes a novel double-layered catalyst system deposited on a monolith reactor wherein the layer in contact with the monolith contains the steam reforming catalyst and the second catalyst layer containing the partial oxidation catalyst is deposited on top of the steam reforming catalyst layer; the steam reforming catalyst comprises one or more platinum group metal components and the catalytic partial oxidation catalyst comprises palladium components. U.S. Pat. No. 6,162,267 claims steam reforming catalyst compositions nickel with amounts of cobalt, platinum, palladium, rhodium, ruthenium, or iridium supported on magnesia, magnesium aluminate, alumina, silica or zirconia. Other exemplary prior art disclosing steam-reforming processes are U.S. Pat. Nos. 5,112,527; 4,927,857; 4,844,837; 4,522,894; and 4,501,823.

There are many improvements that are desirable in the prior art catalysts and processes referred to above: Firstly, the hydrocarbon feedstock must be rigorously desulfurized to less than 0.1 ppm of sulfur since most of the prior art catalysts are deactivated in the presence of sulfur compounds and suffer a drastic reduction in their activity, selectivity and productivity. The desulfurization of hydrocarbon streams, especially petroleum streams like LPG, naphtha, diesel, to such low levels of sulfur is an expensive operation and increases the cost of hydrogen generated by steam reforming. It also increases the volume and, hence, the cost of the fuel processor in fuel cell applications. Improved, sulfur-tolerant steam reforming catalysts are, hence, desirable. Secondly, it is desirable to improve significantly, the activity of the prior art steam reforming catalysts. Most of the prior art steam reforming catalysts operate at Gas Hourly Space velocities (GHSV) of around ten to fifteen thousand (v/v hr); GHSV is defined as the volume of reactant gas stream that is processed by a unit volume of the catalyst bed per hour. GHSV is an indication of the catalyst activity; Greater the activity of the catalyst, higher is the GHSV at which it can function. GHSV values also determine the size of the catalytic reactor and, hence, its cost. Less active catalysts with low GHSV values will require large amounts of catalysts and a correspondingly large reactor with its attendant high cost. GHSV values of ten to fifteen thousand characteristic of prior art steam reforming catalysts, while acceptable in large fertilizer and ammonia plants, need to be increased significantly if the steam reforming catalysts and process are to be used in fuel cell applications, especially in “on-board” reformers for fuel processors in automobiles.

### OBJECTIVES OF THE INVENTION

It is an object of the present invention to provide an improved catalyst, which will result in a more efficient generation of hydrogen than prior art catalysts. It is an additional object of the present invention to provide an improved process for the generation of hydrogen using the improved catalyst. It is a further object of the present invention to provide a steam reforming catalyst that can operate at GHSV values substantially higher than those of prior art catalysts. It is a further object of the present invention to provide for a steam reforming catalyst that can function effectively even in the presence of significant amounts of sulfur compounds. It is yet another object of the present invention to provide a process for the generation of hydrogen by a combination of steam reforming and water gas shift reactions.

### SUMMARY OF THE INVENTION

Accordingly, the present invention provides a catalyst composition comprising:
(a) a Group VIII metal
(b) at least two partially reducible metal oxides chosen from the oxides of cerium, molybdenum, tungsten, vanadium, tin, and chromium
(c) zirconium oxide
(d) lanthanum oxide and
(e) aluminum oxide
   wherein the Group VIII metal comprises nickel, platinum, palladium, rhodium or mixtures thereof and a process for producing a hydrogen-rich gas comprising reacting a sulfur-containing hydrocarbon feedstock with steam over the abovementioned catalyst at a temperature in the range of 600-800° C. wherein the sulfur content of the hydrocarbon feedstock is at least 1 ppm.

### DETAILED DESCRIPTION OF THE INVENTION

During the steam reforming of hydrocarbons, one of the key reactions involved in the generation of hydrogen from hydrocarbons, the hydrocarbon molecule adsorbs on a metal component wherein it undergoes dehydrogenation to adsorbed carbon moieties and adsorbed hydrogen atoms. The latter combine with each other and desorb as H₂, hydrogen molecules, The H₂O molecules, in steam, adsorb on the support and dissociate into H and OH radicals. The OH radicals diffuse on the support surface and migrate onto the surface of the metal component wherein they react with the adsorbed carbon moieties forming adsorbed HCO radicals. The HCO radicals decompose into adsorbed H atoms and adsorbed CO species. The latter, then, desorb into the gas phase. It is known in the prior art that catalyst parameters that facilitate the adsorption and dehydrogenation of the hydrocarbon molecules on the metal surface will enhance the conversions and rates of the steam reforming process; greater the surface area of the metals (Group VIII metals like nickel, platinum, palladium, cobalt etc) greater will be the adsorption and dehydrogenation of the hydrocarbons In contrast, the parameters of the catalyst support that promote the adsorption and dissociation of the H₂O molecule are not so well known in the prior art. Prior art supports like alumina, magnesia or silica, even though they adsorb H₂O readily, are not very efficient in its dissociation and, hence, require high temperatures, usually above 800 C, typical of prior art steam reforming processes, to dissociate H₂O into H and OH.

Prior art catalysts for steam reforming usually consist of two components A and B. A is a metal or an oxide easily reduced to the metallic state, typical examples being nickel, ruthenium or cobalt. B is one or more non-reducible, insulating metallic oxides with large surface areas serving as supports for the active A components, typical examples being alumina, silica, magnesia and magnesium aluminate. As hereinbefore mentioned, components B of the prior art steam reforming catalysts, exemplified by such non-reducible, insulating oxides as alumina, silica, magnesia, magnesium aluminate or combinations thereof, are not efficient in the decomposition of H₂O and generation of OH radicals, the latter being important intermediates in the removal of carbon as CO from the surface of the A component. Improving the H₂O decomposition capability of the catalyst support components, namely B, of the steam reforming catalysts by discovery of novel catalyst compositions, can, hence, enhance the H₂ generation capability of the catalyst thereby fulfilling one of the major objects of the present invention.

### DESCRIPTION OF THE PREFERRED EMBODIMENT (S)

It has been discovered during the investigations leading to the present invention that certain metal oxides, which have the unique characteristic that the metal cations constituted therein are partially and reversibly reducible to lower oxidation states under the process conditions of steam reforming, are surprisingly and unexpectedly able to decompose the H₂O molecules generating the H and OH radicals and thereby constituting significantly improved B components of steam reforming catalysts. Partially and reversibly reducible metal oxides that belong to this category include, as illustrative examples only, the oxides of cerium, tin, chromium, molybdenum, tungsten, and vanadium. These oxides have been found to lose their surface oxide ions, as H₂O, under the conditions of the process of steam reforming and thereby generating oxygen ion vacancies at temperatures significantly lower than those of prior art catalysts mentioned hereinabove. These oxygen ion vacancies, once generated, can serve as active, surface centers for the adsorption and dissociation of H₂O molecules present in the feedstock as illustrated by the following equations:
(Surface oxide ion) O₂₋+H₂ (generated during steam reforming) [symbol] H₂O [symbol] +oxygen ion vacancy;
oxygen ion vacancy+H₂O (present in feedstock) [symbol] OH+H

The OH species, as described hereinbefore, then migrate onto the surface of the active A metal surface components and react with the carbon attached to the metal forming carbon monoxide in the process as illustrated below:
(Hydrocarbon) CHₓ+M (metal) [symbol] M−C (carbon)+xM−H (hydrogen)
OH+M−C [symbol] M−CHO [symbol] M−H+CO

[symbol]

By generating the OH species at a temperature significantly lower than the prior art catalyst supports, the partially reducible metal oxides of the present invention enhance the rates of the overall hydrogen-forming, steam reforming reactions and lead to improved steam reforming catalysts. Illustrative examples of the partially reducible oxides of the present invention, which enhance the decomposition of H₂O and thereby enhance the rates of steam reforming at temperatures significantly lower than the prior art catalysts, include the oxides of cerium, molybdenum, tungsten, vanadium, tin and chromium. When these oxides are present along with metals of Group VIII of the Periodic Table, the resulting catalyst compositions have been found, during the course of the investigations leading to the present invention, to possess superior catalytic activity than the catalysts of the prior art. To illustrate, while the prior art catalysts, exemplified by a commercial catalyst sample containing nickel-magnesia-alumina was active in the steam reforming of methane at a steam to methane molar ratio of 2, and a GHSV of 10,000 only above 800° C., a catalyst composition containing therein nickel-cerium oxide-alumina reached similar levels of activity, under the same conditions of steam/carbon and GHSV, even at 650° C.

While the partially reducible metal oxides mentioned hereinbefore were very active in the steam reforming reaction, a surprising discovery during our investigations was that when two or more such partially reducible metal oxides were present simultaneously in the same catalyst composition, the resulting catalyst was even more active enabling the steam reforming reaction to be carried out at much higher values of GHSV and reactor throughput. To illustrate, when the abovementioned catalyst composition included, in addition to cerium oxide, the oxide of tin, similar levels of catalytic activity in the steam reforming of methane were reached even when the GHSV value was increased from 10,000 to 100,000 at otherwise identical temperatures of 650° C. and steam/carbon value of 2.

Accordingly, one embodiment of the present invention is a catalyst composition containing at least two metal oxides which are only partially reducible to lower metal oxides under the process conditions of steam reforming; Illustrative examples of such metal oxides include the oxides of cerium, vanadium, chromium, molybdenum, tungsten and tin.

According to another embodiment of the present invention, the catalyst composition includes at least one metal of the Group VIII of the Periodic Table; Illustrative examples include nickel, platinum, palladium and rhodium.

The catalytic performance of the catalyst composition containing the Group Vil metal and two of the partially reducible metal oxides, hereinbefore described, while superior, initially, to the prior art catalysts not containing two of the partially reducible metal oxides, underwent a slow deactivation. A surprising discovery during the course of the present invention was that when the catalyst composition included, in addition to the Group VIII metals and two of the partially reducible metal oxides, the oxide of ZrO₂, the resulting steam reforming catalyst had a more stable and longer catalytic performance. One of the possible modes by which ZrO₂ imparts superior characteristics to the catalyst composition, is by stabilizing the dispersion and surface area of the partially reducible metal oxide against sintering under the hydrothermal conditions of calcinations and reaction at high temperatures.

Accordingly, one embodiment of the present invention is a catalyst composition containing an oxide of zirconium in addition to the Group VIII metal and at least two metal oxides which are only partially reducible under the conditions of steam reforming.

Since catalytic activity is proportional to the surface area of the active Group VIII metals and the partially reducible metal oxides, the constituents of the catalyst of the present invention are advantageously supported on an inert and rugged, high surface area metal oxide support.

In a preferred embodiment of the present invention the metal oxide support is aluminum oxide or alumina. High surface area aluminum oxides contain acidic sites on their surface. These acidic sites react with reaction intermediates during the steam reforming reaction forming heavy hydrocarbon moieties, which poison the progress of the reaction. An additional disadvantage of the use of alumina at elevated temperatures under hydrothermal conditions, as during a steam reforming process, is that the crystalline structure of alumina undergoes conversion to a more dense material with a lower surface area and consequent lower catalytic activity. We have found that the addition of lanthanum oxide to the alumina support leads, not only to the removal of the surface acidic sites but also to the stabilization of the crystalline structure and crystallite size of alumina against sintering and loss of surface area.

Accordingly, in yet another embodiment of the present invention, the composition of the steam reforming catalyst of the present invention contains lanthanum oxide.

### EXAMPLE

It is anticipated that those having ordinary skills in the art can make various modifications to the various embodiments disclosed herein after learning the teaching of the present invention, which is further illustrated by the following nonlimiting examples.

### Example 1

### Preparation of a Prior Art Catalyst, A.

This example illustrates the preparation of one of the prior art catalysts for steam reforming. The chemical composition of the catalyst was: 40%(w/w) nickel-60% an equimolar mixture of Al₂O₃ and MgO. The catalyst was prepared by the coprecipitation, from a mixture of the appropriate quantities of the nitrates of nickel, aluminum and magnesium, their corresponding hydroxides at a pH of 9.0, digesting the freshly precipitated mixture of hydroxides at a temperature of 80° C. for 72 hours, filtering the solid precipitate and washing it thoroughly with water, drying at 120° C. and calcining in air at 500° C. The catalyst was reduced in situ in the catalytic reactor before the reaction by 10% hydrogen in nitrogen in a programmed manner starting from 200° C., the final temperature of reduction being 550° C. This catalyst is designated as catalyst A.

### Example 2

### Composition and Preparation of Catalysts of the Present Invention

This example illustrates the preparation of improved catalysts of the present invention. The chemical composition of the catalyst was 15%(w/w) Ni-30%(w/w) CeO₂-5%(w/w) Cr₂O₃-20%(w/w) Zr₂-3%(w/w) La₂O₃-27%(w/w) Al₂O₃. The catalyst support comprising the mixture of oxides of cerium, lanthanum and aluminum was prepared by coprecipitation of their hydroxides from appropriate quantities of the mixtures of their nitrates, prolonged digestion at 80° C., filtering, washing drying and calcinations by procedures similar to those illustrated in Example 1. To the mixture of calcined oxides of cerium, lanthanum and aluminum thus obtained, the oxide of chromium was impregnated from an aqueous solution containing the appropriate quantity of chromic acid. The material, after drying at 120° C. and calcining at 500° C., constituted the catalyst support. 15% by weight of nickel was deposited on this catalyst support by “dry” impregnation by immersing the solid support in a volume of aqueous solution containing the appropriate quantity of nickel as nickel nitrate wherein the volume of the aqueous solution was equal to the pore volume of the solid support (0.6 ml/gm of solid). This catalyst is designated as catalyst B. Following procedures similar to those described hereinbefore, catalysts C-I were prepared. Their chemical compositions were:
Catalyst C: 5% Pt-25%-CeO₂-20% V₂O₅-20% ZrO₂-3% La₂O₃-27% Al₂O₃
Catalyst D: 3% Pd-27% CeO₂-20% Cr₂O₃-20% ZrO₂-3% La₂O₃-27% Al₂O₃
Catalyst E: 4% Pt-1% Rh-25% MoO₃-20% CeO₂-20% ZrO₂-3% La₂O₃-27% Al₂O₃
Catalyst F: 5% Pt-25% SnO₂-20% V₂O₅-20% ZrO₂-3% La₂O₃-27% Al₂O₃.
Catalyst G: 4% Pt-1% Rh-25% MoO₃-20% CeO₂-3% La₂O₃-47% Al₂O₃
Catalyst H: 4% Pt-i % Rh-25% MoO₃-20% CeO₂-50% Al₂O₃
Catalyst I: 4% Pt-1% Rh-45% CeO₂-3% La₂O₃-47% Al₂O₃

### EXAMPLE 3

### Catalyst Evaluation in the Absence of Sulfur Compounds in the Feedstock

Catalysts A-F were evaluated at 650° C. in an integral packed bed reactor. All the catalysts were used in the form of 40-60 mesh particles. Iso-octane and water were the reactants. Their flow into the reactor was controlled with mass flow controllers or syringe pumps. The products were analyzed “on line” using gas chromatography. The molar ratio of steam to carbon was fixed at a value of 2.0. The conversions of iso-octane are given below.

| | | | | | | Others, % |
|---|---|---|---|---|---|---|
| | GHSV | % conv. of | | | | (mainly |
| catalyst | (per hour) | iso-octane | % H₂ | % CO | % CO₂ | methane) |
| A | 15,000 | 50 | 71 | 7 | 10 | 12 |
| B | 80,000 | 90 | 74 | 8 | 16 | 2 |
| C | 100,000 | 95 | 73 | 13 | 11 | 3 |
| D | 100,000 | 96 | 70 | 9 | 18 | 3 |
| E | 100,000 | 98 | 71 | 12 | 14 | 3 |
| F | 100,000 | 96 | 70 | 9 | 17 | 4 |

### Example 4

Catalysts A-F were evaluated using iso-octane containing 20 ppm of sulfur in the form ethyl mercaptan. Other conditions of catalyst evaluation were the same as in Example 3. Catalyst A was deactivated within one day of operation. In the case of the other catalysts, there was an initial decrease in the catalytic activity, which after a few hours, stabilized at around 80-90% conversion of methane; the distribution of the products was not significantly affected except that there was an increase in the ratio of CO/CO₂. The amount of CO in the product was more than that of carbon dioxide indicating that the water gas shift catalytic activity was being adversely affected.

### Example 5

This example illustrates the superior catalytic performance of the steam reforming catalyst when two or more partially reducible metal oxides are present together simultaneously in the catalyst formulation than when only one of them is present. Catalysts H and I were compared under identical process reaction conditions of 600° C., a GHSV=85000 per hr and a steam to carbon ratio of 2.0. Iso-octane was the hydrocarbon feed, Catalyst H containing two partially reducible oxides, namely molybdena and ceria was more active, converting 85% of iso-octane while catalyst I containing only cerium oxide was able to convert only 72% of the hydrocarbon to products.

### EXAMPLE 6

This example illustrates the superior catalytic performance of the steam reforming catalyst when ZrO2 is present in the catalyst formulation. Catalysts E and G were compared using iso-octane as the hydrocarbon feed, under identical process reaction conditions of temperature 700° C., GHSV=100,000, and steam to carbon ratio of 1.5. Even though both Catalysts E and G had similar initial catalytic activity, after 200 hours of continuous operation, catalyst E containing ZrO₂, had a higher conversion of the hydrocarbon than catalyst G which did not contain ZrO₂, by about 4% wt. The greater dispersion of the partially reducible metal oxides by the ZrO₂ and, especially, the greater stabilization of the dispersion of the partially reducible metal oxides by ZrO₂ is probably the reason for the superior catalytic performance of the steam reforming catalyst when ZrO₂ is included in the catalyst composition as in catalyst E.

### Example 7

This example illustrates the superior catalytic performance of the steam reforming catalyst when La₂O₃ is present in the catalyst formulation. Catalysts G and H were compared using iso-octane as the hydrocarbon feed, under identical process reaction conditions of temperature 650° C., GHSV 100,000, and steam to carbon ratio of 1.5. Even though both Catalysts G and H had similar initial catalytic activity, after 75 hours of continuous operation, catalyst G containing La₂O₃, had a higher conversion of the hydrocarbon than catalyst H which did not contain La₂O₃, by about 8% wt. This beneficial effect of La₂O₃ is probably due to the fact that acidic sites present in alumina have been passivated by La₂O₃. The stabilization of the alumina support against hydrothermal sintering at elevated temperatures by lanthanum ions present in the alumina structure is an additional probable reason for the greater structural stability and consequent more stable catalytic activity of catalyst G compared to catalyst H.

The improved steam reforming catalyst and process used in the present invention demonstrates high catalytic activity at GHSV space velocities much higher than those in conventional reforming catalysts and processes. This superior characteristic of the catalysts of the present invention, when used advantageously in fuel processors for supplying hydrogen to fuel cells, lead to a significant reduction in the volume and, consequently, the cost of manufacture of the fuel processor.

It should be appreciated that the present invention is not limited to the specific embodiments described above, but includes variations, modifications and equivalent embodiments defined by the following claims.

1. An improved steam reforming catalyst composition comprising:
a. Nickel, platinum, palladium, rhodium or combinations thereof;
b. at least two partially reducible metal oxides chosen from the oxides of cerium, molybdenum, tungsten, vanadium, tin and chromium;
c. zirconium oxide
d. lanthanum oxide and
e. aluminum oxide
wherein the Group VIII metal comprises nickel, platinum, palladium, rhodium or mixtures thereof.

2. An improved steam reforming process for producing a hydrogen-rich gas comprising reacting a sulfur-containing hydrocarbon feedstock with steam over the catalysts of claim 1 at a temperature in the range of 600-900° C. wherein the sulfur content of the hydrocarbon feedstock is at least 1 ppm.

3. A steam reforming process according to claim 2 wherein the sulfur-containing hydrocarbon feedstock is natural gas, liquefied petroleum gas, naphtha, gasoline, kerosene, jet fuel, diesel, or methane.
